(19) United States
(12) Patent Application Publication
(10) Pub. No.: US 2013/0161263 A1
(43) Pub. Date: Jun. 27, 2013

(54) ENHANCED ADVANCED OXIDATION PROCEDURE

(71) Applicant: A. SHITZER LTD., Haifa (IL)

(72) Inventors: Joshua GAD-EL, Haifa (IL); Benjamin MOSENSON, Haifa (IL); Boaz SHITZER, Haifa (IL)

(73) Assignee: A. SHITZER LTD., Haifa (IL)

(21) Appl. No.: 13/775,032

(22) Filed: Feb. 22, 2013

Related U.S. Application Data
(63) Continuation of application No. PCT/IL2011/000679, filed on Aug. 22, 2011.

(30) Foreign Application Priority Data
Aug. 24, 2010 (IL) 207783

(51) Int. Cl. C02F 9/00

(52) U.S. Cl. CPC C02F 9/00; B82Y 99/00
USPC 210/703; 210/748.04; 210/739; 210/721; 977/902; 977/775

(57) ABSTRACT

An advanced oxidation procedure for treating solution waste water, comprising: applying an ultrasound-Fenton reaction, wherein said ultrasound-Fenton reaction includes: providing oxidants and at least one catalyst selected from bivalent metal ions which include Ti, Fe, Mg, Mo, and Cu; subjecting the treated solution and said oxidants and catalyst to ultrasound cavitation generated by a generator device; forcing a flow of treated solution through said ultrasound device adapted to generate ultrasound waves for forming cavitation in said treated solution, said flow of treated solution passing through at least one flow-through tubular reactor chamber of the ultrasound device, and wherein said cavitation is effected by longitudinally linear distributed string of ultrasound transducers fixedly disposed and attached along a length of said at least one tubular reactor chamber, and wherein said cavitation is effected along a width dimension of said reactor chamber.

The present application claims benefit of International Application No. PCT/IL2011/000679 filed on 22 Aug. 2011, the priority date of which is claimed herein, and the entire contents of which is incorporated herein by reference.

### TECHNICAL FIELD

The present invention relates to decontamination processes, and in particular to the decontamination of industrial wastewater containing organic matter untreatable by common biologic degradation methods.

### BACKGROUND

Most of the contaminants in industrial wastewater can be treated by bacterial (Bio) degradation, but a large group of contaminating chemicals, which are toxic to humans and the environment, are still contaminating water air and soil. These chemicals are known as non-degradable since they are not decomposed by any bacterial cultures and have to be dealt with by some other decomposition method.

It is well established in the professional literature that the decontamination and degradation of chemicals which are oxygen demanding and are considered as water contaminants can be treated and oxidized by the ultrasound-Fenton procedure. The reaction of the ultrasound-Fenton procedure is catalyzed by the addition of peroxide and bivalent metal ions. The bivalent ion for the Fenton procedure have the ability to be transferred from one oxidative state to another, for example, iron either as Fe⁺² or Fe⁺³ ions. The resonance of the electrons makes it possible to produce free radicals in the reaction solution.

However, a possible disadvantage of the ultrasound-Fenton procedure is that the generic metal ions that are added to the reaction solution as salts or oxidants of the metal, such as FeSO₄ and TiO₂, both have a crystal formation of relative large size, i.e. in the order of magnitude of millimeters. Such a crystalline formation has a small surface area, thus offering a small interacting area between the metal and the oxidizer, whereby the reaction's kinetic constant is relatively low.

Another disadvantage is that the use of generic metal ions has a negative impact on the effectiveness of the reaction of the ultrasound-Fenton procedure. For example, pH level required for maximum solubility of the conventionally used metal ions has a very narrow range that is limited to a pH level spanning between 2.7 and 3.

Evidently, the pH level of the treated solution has to be adjusted by pretreatment, for example by adding acid such as hydrochloric or sulfuric acids, which results in additional costs for the purchase of additives and further labor expenses. Moreover, the addition of acids may introduce undesirable components to the mixture.

It would therefore be beneficial to provide an enhanced advanced oxidation procedure, referred hereinafter as AOP, adapted for decontamination of industrial wastewater operative for the degradation of organic matter untreatable by common biologic degradation methods.

Also to provide the AOP that presents superior results in a relatively short time of reaction.

### Technical Problem

Decontamination and/or disinfection of industrial wastewater containing organic matter untreatable by common biological degradation processes is an unsolved problem. Such undegradable industrial wastewater, is toxic, dangerous, and harmful to the environment.

### Solution to the Problem

The solution is provided by applying an enhanced advanced oxidation process, the AOP, to a treated solution. The AOP may be part of a multi-stage treatment process including pretreatment process(es), intermediate process(es), post treatment process(es) and combinations thereof.

In one embodiment of the present invention, the AOP operates on the treated solution by using an ultrasound device and an ultrasound reactor. The ultrasound reactor is a tubular flow-through ultrasound reactor having a singular configuration, and operates at selected ultrasound parameter settings and under predetermined solution circulation conditions. Such treated solution forcibly flows through a tubular flow-through reactor chamber having predefined dimensions, in a predetermined number of cycles. In parallel, the ultrasound reactor is provided with a set of ultrasound transducers disposed in a predetermined longitudinal string linear distribution that is adapted to operate at specifically selected parameters to generate a desired cavitation process. It has been found that the exposure time and the number of cycles of ultrasonic cavitation, or sonocation, which the treated solution is exposed to plays an important role in the efficiency of the oxidative process, as well as the nature of the catalysts, the energetic load or power density, the pH level, the reactor's configuration and the like.

The AOP may further be improved into a chelate nanocrystal process, referred to hereinafter as CNP. This can be achieved by adding to the treated solution at least one catalyst. The catalyst may be configured as nanoscale chelate crystal, and/or nanocrystals in a formulation kept active within a multi-metal solution.

A further treatment may be applied, as a post treatment process. At the post treatment process, a test may be added for assessing the quality of the treated wastewater by measuring the chemical oxygen demand, also referred to as COD, and/or by measuring the total organic carbon, also referred to as TOC. Such measurements may confirm the efficacy of the presently claimed invention.

### SUMMARY

The present invention relates to a processes, and in particular to the decontamination of industrial wastewater containing organic matter untreatable by common biologic degradation methods.

In accordance with embodiments of one aspect of the present invention there is provided an advanced oxidation procedure for treating solution 10 of waste water, which includes:
applying an ultrasound-Fenton reaction, wherein the ultrasound-Fenton reaction includes:
providing oxidants 40 and at least catalyst 50, wherein the at least one catalyst is selected from the group consisting of a group of bivalent metal ions which includes Ti, Fe, Mg, Mo, and Cu;
subjecting the treated solution 10 and said oxidants 40 and at least catalyst 50 to ultrasound cavitation generated by generator device 20;
forcing a flow of treated solution 10 through the ultrasound device 20 adapted to generate ultrasound waves for forming cavitation in the treated solution 10, the flow of treated solution 10 passing through at least one flow-through tubular reactor chamber 24 of the ultrasound device 20, and wherein the cavitation is effected by longitudinally linear distributed string of ultrasound transducers 26 fixedly disposed and attached along a length L of the at least one tubular reactor chamber 24, and wherein the cavitation is effected along a width dimension WD of the reactor chamber 24, and wherein the ultrasound transducers 26 emit a frequency in a range of 15 kHz to 50 kHz, at an energetic load of 0.1 to 1.5 kW h/m³.

According to an aspect of some embodiments of the invention, the subject further comprises at least one step selected alone and/or in combination from a group consisting of measuring a COD level, measuring a TOC level, and adjusting a pH level.

According to an aspect of some embodiments of the invention, the at least one flow-through tubular reactor chamber 24 includes:
the length dimension L, and a first reactor wall having a reactor inlet IN through which the treated solutions 10 enters the at least one reactor chamber and flows to a second reactor wall having a reactor outlet OUT through which the treated solution 10 exits out of the at least one reactor chamber, and
the diameter WD, or a width dimension WD perpendicular to the reactor chamber length L, which width dimension is ranging from 25 to 300 mm.

According to an aspect of some embodiments of the invention, the AOP future comprises the step of: forcing the treated solution 10 to flow through the at least one reactor chamber 24 for a number of cycles selected from a group consisting of 1 to 10 cycles per hour, wherein the forcing is adapted to be controlled by a circulation pump 30, and wherein the at least one reactor chamber 24 is adapted for achieving an ultrasound cavitation exposure time of the treated solution for a period of time of 1 to 60 seconds.

According to an aspect of some embodiments of the invention, the width dimension WD is between 50 to 250 mm.

Optionally, the width dimension WD is 125 mm.

According to an aspect of some embodiments of the invention, the frequency of operation of the ultrasound transducers 26 is adapted to emit 15 kHz to 50 kHz.

Optionally, the frequency of operation of the ultrasound transducers is adapted to emit 25 kHz.

According to an aspect of some embodiments of the invention, the energetic load is between 0.2 to 0.7 kW h/m³.

Optionally, the energetic load is adapted to 0.3 kW h/m³.

According to an aspect of some embodiments of the invention, the AOP, further comprises the step of:
forcing the treated solution to flow through the at least one reactor chamber 24 for a number of cycles, wherein the number of cycles is adapted to 2 to 8 cycles per hour.

According to an aspect of some embodiments of the invention, the AOP further includes the step of:
forcing the treated solution to flow through the at least one reactor chamber 24 for 3 cycles per hour.

According to an aspect of some embodiments of the invention, the AOP further includes the step of:
forcing the treated solution to flow through the at least one reactor chamber 24 for 3 cycles per hour for up to two hours.

According to an aspect of some embodiments of the invention, the AOP further includes the step of: adapting the at least one reactor chamber for achieving an ultrasound cavitation exposure time of the treated solution for a period of time of 2 to 15 seconds.

Optionally, the AOP further includes the step of: adapting the at least one reactor chamber for achieving an ultrasound cavitation exposure time of the treated solution for a period of time of 8 to 15 seconds.

Optionally, the AOP further includes the step of: adapting the at least one reactor chamber 24 for achieving an ultrasound cavitation exposure time of the treated solution for a period of time of at least 12 seconds.

According to an aspect of some embodiments of the invention, the AOP includes the step of:
applying a pretreatment process prior to the ultrasound-Fenton reaction for removing oily matter selected alone and/or in combination from the group consisting of mineral oil, suspended solids, and sedimentation of suspended solids originating from dissolved solids treated by precipitation or flotation.

According to an aspect of some embodiments of the invention, the AOP further includes the steps of:
operating the AOP for a period of two hours, and thereafter
applying a post treatment process for removing metal ions from the treated solution 10.

In an embodiment of the invention, an advanced oxidation procedure using nanoscale-chelate crystals catalyst in a chelate nanocrystal process includes:
applying an ultrasound-Fenton reaction, wherein the ultrasound Fenton reaction including:
   providing oxidants 40 and at least catalyst 50, wherein the at least one catalyst is selected from the group consisting of bivalent metal ions which includes Ti, Fe, Mg, Mo, and Cu;
subjecting the treated solution 10 and the oxidants 40 and at least catalyst 50 to ultrasound cavitation generated by generator device 20, wherein the ultrasound cavitation produces the nanoscale-chelate of catalyst in a formulation kept active in a multi-metal solution, wherein the nanoscale-chelates of catalyst is adapted to at least twofold level of solubility relative to a conventional catalyst in spectrum of pH levels ranging from 1 to 6, and
forcing a flow of treated solution 10 and the nanoscale-chelates of catalyst through the ultrasound device 20 adapted to generate ultrasound waves for forming cavitation in the treated solution 10, the flow of treated solution 10 passing through at least one flow-through tubular reactor chamber 24 of the ultrasound generator device 20, and wherein the cavitation is effected by longitudinally distributed linear string of ultrasound transducers 26 fixedly disposed and attached along a length L of the at least one tubular reactor chamber 24, and wherein the cavitation is effected along a width dimension WD of the reactor chamber 24, and wherein the ultrasound transducers 26 emit a frequency in a range of 15 kHz to 50 kHz, at an energetic load of 0.1 to 1.5 kW h/m³.

According to an aspect of some embodiments of the invention, the CNP further includes at least one step selected alone and/or in combination from a group consisting of measuring a COD level, measuring a TOC level, and adjusting a pH level.

According to an aspect of some embodiments of the invention, the at least one flow-through tubular reactor chamber 24 includes:
said length dimension L, and a first reactor wall having a reactor inlet IN through which said treated solutions 10 enters the at least one reactor chamber and flows to a second reactor wall having a reactor outlet OUT through which the treated solution 10 exits out of the at least one reactor chamber, and
said diameter WD, or a width dimension WD perpendicular to the reactor chamber length L, which width dimension is ranging from 25 to 300 mm.

According to an aspect of some embodiments of the invention, the CNP future includes the step of: forcing the treated solution 10 to flow through the at least one reactor chamber 24 for a number of cycles selected from a group consisting of 1 to 10 cycles per hour, wherein said forcing is adapted to be controlled by a circulation pump 30, and wherein the at least one reactor chamber 24 is adapted for achieving an ultrasound cavitation exposure time of the treated solution for a period of time of 1 to 60 seconds.

According to an aspect of some embodiments of the invention, the selected nanoscale-chelates of catalyst is adapted to be produced by
reacting at least one of the bivalent metal ions of Ti, Fe, Mg, Mo, and Cu with a chelating agent selected alone and/or in combination from the group consisting of EDTA, citric acid, hydroxy acetic acid, phosphate sequesting polymers, acrylic polymers, and mercaptans or thions, to create a wide-range pH soluble complex, and
treating the wide-range pH soluble complex by disposition in said ultrasound reactor 24 having at least 50 W to 1000 W, and exposure to ultrasonic cavitation for a duration of 15 minutes to 150 minutes for at least 60 minutes.

According to an aspect of some embodiments of the invention, the selected nanoscale chelates of catalyst present an increased surface area larger by at least one order of magnitude relative to a conventional catalyst.

Optionally, the increased surface area of the selected nanoscale-chelates of catalyst enables at least a twofold reaction kinetic constant increase.

According to an aspect of some embodiments of the invention, the selected nanoscale chelates of catalyst enables optimal reaction in a treated solution having an acidity pH level of about 6.

According to an aspect of some embodiments of the invention, the selected nanoscale chelates of catalyst produced by chelation and nanoscaling processes, is adapted to treat wastewaters containing multi-components of organic contaminants as a result of chelation and nanoscaling.

According to an aspect of some embodiments of the invention, the width dimension WD is between 50 to 250 mm.

Optionally, the width dimension WD is 125 mm.

According to an aspect of some embodiments of the invention, the ultrasound transducers 26 are adapted to emit a frequency of 15 kHz to 50 kHz.

Optionally, the ultrasound transducers are adapted to emit a frequency of 25 kHz.

According to an aspect of some embodiments of the invention, the energetic load is between 0.2 to 0.7 kW h/m³.

Optionally, the energetic load is adapted to 0.3 kW h/m³.

According to an aspect of some embodiments of the invention, the CNP further comprises the step of:
forcing the treated solution to flow through the at least one reactor chamber 24 for a number of cycles, wherein the number of cycles is adapted to 2 to 8 cycles per hour.

Optionally, forcing the treated solution to flow through the at least one reactor chamber 24 for 3 cycles per hour.

Optionally, forcing the treated solution to flow through the at least one reactor chamber 24 for 3 cycles per hour for up to two and a half hours.

According to an aspect of some embodiments of the invention, the CNP further includes the step of:
adapting the at least one reactor chamber 24 for achieving an ultrasound cavitation exposure time of the treated solution for a period of time of 2 to 15 seconds.

Optionally, The CNP further includes the step of:
adapting the at least one reactor chamber 24 for achieving an ultrasound cavitation exposure time of the treated solution for a period of time of 8 to 15 seconds.

Optionally, the CNP further includes the step of:
adapting the at least one reactor chamber 24 for achieving an ultrasound cavitation exposure time of the treated solution for a period of time of at least 12 seconds.

According to an aspect of some embodiments of the invention, the CNP further includes the step of:
applying a pretreatment process for removing oily matter selected alone and/or in combination from a group consisting of mineral oil, suspended solids, and sedimentation of suspended solids originating from dissolved solids treated by precipitation or flotation.

According to an aspect of some embodiments of the invention, the CNP further includes the steps of:
operating the enhanced advanced oxidation procedure for a period of two and one half hours, and thereafter
applying a post treatment process for removing metal ions from the treated solution.

### BRIEF DESCRIPTION OF THE DRAWINGS

The present invention will be understood and appreciated more fully from the following detailed description taken in conjunction with the appended drawings in which:

FIG. 1 is a block diagram illustrating a system adapted to operate the enhanced AOP of the present invention;

FIG. 2 is a perspective view of the ultrasound device of the present invention; and

FIGS. 3-7 are graphic representations of the COD reading results obtained after post-treatment of the treated test solution.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DESCRIPTION OF EMBODIMENTS

### Advanced Oxidation Process

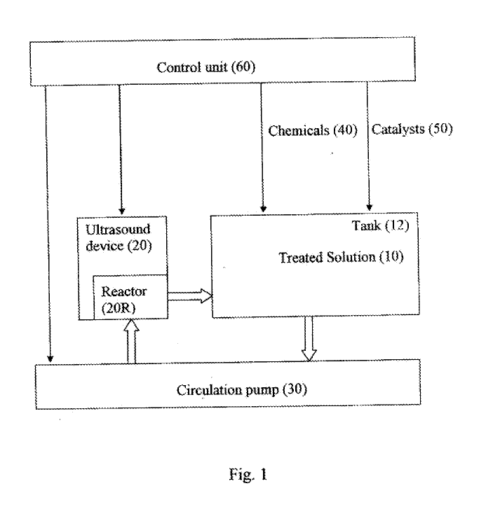

Illustrative embodiments of the invention are described below. In the interest of clarity, not all features/components of an actual implementation are necessarily described. FIG. 1 is a simplified block diagram that illustrates an operational system for the AOP, based on an ultrasound—Fenton reaction, for the decontamination of industrial wastewater. The AOP is adapted to operate a singular ultrasound device, process on a volume Vₒ of a treated solution 10 containing toxic organic matter, and degrades organic matter untreatable by known biologic degradation methods in the presence of oxidation chemicals and catalysts.

The AOP may be part of a multi-stage process including one or more various pretreatment, intermediate, and/or post-treatment processes. A pretreatment process may includes, for example, but is not limited to, removal of oily substances, of solids suspended in the treated solution of wastewater, and of suspended solids' sediments produced from dissolved solids treated by chemical reactions, reactions which are as well known to those skilled in the art.

In another example of the pretreatment process, the AOP may apply the ultrasound—Fenton reaction including the application to the treated solution of one or more process steps selected alone and/or in combination thereof. Such process steps may include but are not limited to, the measurement of the chemical oxygen demand level, also referred to as COD level, the measurement of the total organic carbon level, also referred to as TOC level, the adjustment of the pH level, the addition of chemicals 40, such as oxidants and the like, and the addition of catalysts 50. One or more catalysts 50 may be selected alone and/or in combination from bivalent metal ions such as Ti, Fe, Mn, Mo, Cu, and the like. Such preliminary treatment process stages are well known to those skilled in the art

A post treatment process for the AOP treatment may be considered, typically the post treatment processes are well known to those skilled in the art, including removal of metal ions from the treated solution, as well as the measurement of levels of the COD, the TOC, and the pH.

According to FIG. 1, selected chemicals 40 and catalysts 50 are added to the treated solution 10, under control of a control unit 60. Control unit 60 is adapted to control, command, and manage operation of the system and of the enhanced AOP and method. Thus, the control unit 60 is adapted to control the treated solution 10 entering and exiting to a tank 12, an ultrasound device 20, an ultrasound reactor chamber 20R, a circulation pump 30, the flow rate of the chemicals 40, and the flow rate of the catalysts 50.

Treated solution 10 exiting tank 12 is fed into the ultrasound device20. The feed flow into ultrasound device 20 is controlled by circulation pump 30. Circulation pump 30 forces treated solution 10 into ultrasound device 20 from which treated solution 10 flows back to tank 12. According to an embodiment, within the ultrasound device 20 the treated solution is introduced into the ultrasound reactor 20R. According to an embodiment, ultrasound cavitation, or sonocation, is applied to a sample, or a portion of the treated solution 10 that flows through and resides within the ultrasound reactor 20R.

Ultrasound cavitation is generated according to a selected power setting. The ultrasound cavitation is adapted to be applied to the treated solution 10 as long as the treated solution stays within the reactor 20R. Ultrasound cavitation is applied to the treated solution 10 each time the treated solution 10 flows through the ultrasound reactor 20R. Thus, for each cycle of flow of the treated solution 10 through the ultrasound reactor 20R, the exposure of the treated solution 10 to cavitation is repeated.

The ultrasound reactor 20R houses a tubular reactor chamber 24 having a given volume Vr. In the tubular reactor chamber 24, a longitudinal string linear distribution of ultrasound transducers operates at a predetermined level of power, and at a predetermined energetic load or power density. The control unit 60 controls the operating power of the ultrasound device 20.

Control unit 60 may be preloaded with operative parameters necessary for efficient performance of the enhanced AOP method, such as, but not limited to the number of cycles, and the circulation rate of flow of the treated solution 10 into and out from reactor 20R, defining the time of exposure to ultrasound cavitation.

At the end of the AOP a processed treated solution is produced. Followed the enhanced AOP, a post treatment process may be applied to the processed treated solution. In order to confirm the level of decontamination of the processed treated solution, a COD test may be applied.

### The Ultrasound Device

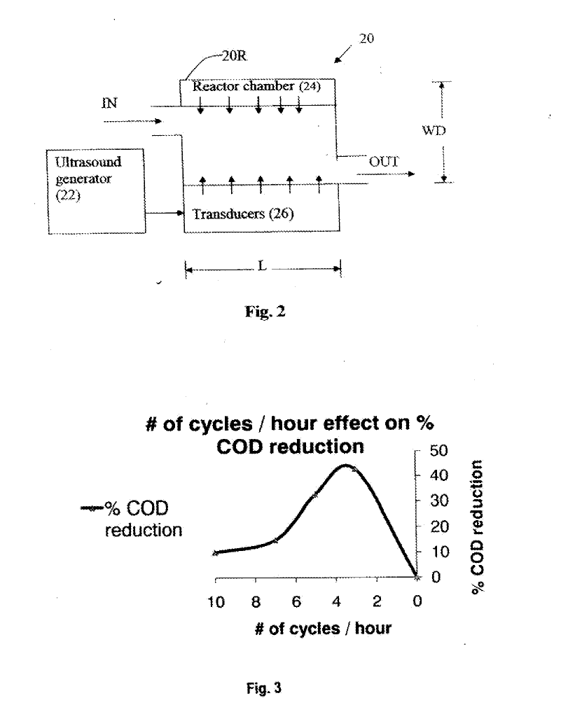

As shown in FIG. 2, the ultrasound device 20 typically houses an ultrasound reactor 20R that includes an ultrasound generator 22, a reaction chamber 24, and a set of ultrasound transducers 26 disposed in a predetermined longitudinal string linear distribution. Circulation pump 30, not shown in FIG. 2, forces the flow of treated solution 10 through the tubular flow-through reactor chamber 24 of the of the ultrasound reactor 20R. In reactor chamber 24, treated solution 10 is submitted to ultrasonic cavitation.

The tubular reactor chamber 24 has a reactor chamber dimension L, and has a first reactor wall having a reactor inlet (IN in FIG. 2) through which treated solutions 10 enters reactor chamber 24 and flows therein to a second reactor wall having a reactor outlet (OUT in FIG. 2) through which treated solutions 10 exits reactor chamber 24. According to an embodiment, the ultrasound reactor chamber 24 length (L in FIG. 2) may be selected to be rectilinear. According to an embodiment, ultrasound reactor chamber 24 length L may have any desired shape such as for example to be curved, to be configured as a spiral, as long as the path of flow between the inlet IN and the outlet OUT has the length L.

The length L of the tubular reactor chamber 24 may be selected in the range between 500 to 1800 mm, and preferably between 700 to 1800 mm long. According to a preferred embodiment, length L is 1500 mm long.

The reactor chamber 24 further has a reactor chamber diameter (WD in FIG. 2), also referred as a width dimension WD. Typically width dimension WD is perpendicular to the reactor chamber length L. According to an embodiment, width dimension may be selected at a width ranging from 25 to 500 mm, preferably from 75 to 250 mm According to a preferred embodiment, width dimension has a width dimension of 125 mm.

Reactor chamber 24 dimensions define a reactor volume Vᵣ, which may be smaller than the volume Vo of the treated solution 10.

The longitudinal linear string distribution of ultrasound transducers 26 may be disposed in abutment along the length L of reactor chamber 24 to initiate ultrasonic cavitation perpendicular the length L and in the direction of the width dimension WD. The direction of the cavitation is shown in FIG. 2 as parallel arrows crossing from the transducers block 26 into the reactor chamber block 24.

The ultrasound generator 22 is adapted to drive the ultrasound transducers 26 to emit a selected frequency ranging from 15 kHz to 50 kHz. If desired, the frequency may be selected as ranging from 30 to 45 kHz, preferably having a value of 25 kHz.

The ultrasound reactor 20R may be selected to operate at an energetic load ranging from 0.1 to 1.5 kW h/m³. If desired, the energetic load of operation may be selected in the range of 0.2 to 0.7 kW h/m³, preferably, at energetic load of 0.3 kW h/m³.

In process, treated solution 10 is forced to flow in a specific number of cycles through reactor chamber 24. It is noted that more than one reactor chamber 24 may participate in the flow-through ultrasound cavitation process to accommodate a dictated flow rate.

Reactor chamber length L and reactor chamber volume V, are adapted such that the entirety of volume Vₒ, of treated solution 10, may flow through the reactor chamber 24 for a predetermined number of cycles per hour. For example, the number of cycles for the entire volume Vₒ to pass through volume Vᵣ, of the reactor chamber 24, may be selected in the range of 1 to 10 cycles per hour. However, if desired, one may select 2 to 8 cycles per hour, preferably 3 cycles per hour.

Moreover, length L and volume Vᵣ are adapted such that the sample of treated solution 10 is exposed to ultrasound cavitation for a pre-selected time period of duration. For example, such ultrasound cavitation exposure period of time may be selected to include a range of 1 to 15 seconds, preferably range of 8 to 15 seconds, preferably at least 12 seconds, preferably 12 seconds.

For operating the enhanced AOP, preliminary process steps may include adding chemicals 40 to the treated solution 10. Chemicals 40 may be selected from the group consisting of oxidizers such as hydrogen peroxide, ozone, hypochloride, and the like. Further steps may include the addition of catalysts 30 to the treated solution 10.

### The Chelate Nanocrystal Process (CNP)

The AOP may further be improved by applying a chelate nano-crystal process, referred to as CNP, to provide even better performance. This chelate nanocrystal process may be achieved by adding at least one catalyst 50 to treated solution 10. Catalyst 50 in the presence of chemicals 40 may be configured as nanoscale chelates crystals, and/or nano crystals, at a formulation kept active within a multi-metal solution.

The improvement may include the aforementioned ultrasound cavitation treatment of the enhanced AOP, including the predefined parameter settings of ultrasound device 20, the number of cycles of flow through reactor 20R, and the exposure time to ultrasound cavitation of treated solution 10.

Traditional and/or conventional catalysts are known and commonly used in AOP. In AOP, a dose of metal ions in their salt configuration and/or as metal oxides may be added to solution 10. As an example of a catalyst originated from salt, one may consider Fe²⁺ that may be found as FeSO₄. As an example of a catalyst originated from oxide, one may consider Ti⁴⁺ which may be found as TiO₂.

However, such abovementioned conventional catalysts typically cause problems by reducing the efficiency of the catalytic action of the metal ions. Such problems include:
a. The conventional salts and/or oxides that supply the metal ions are provided in the form of chelates having a crystal formation that is relatively large, i.e. with a diameter in the range of at least one millimeter. Such crystal formations present a surface area that is relatively small, with a small contact area between catalyst(s) 50 and chemical oxidizer 40. Small contact areas typically slow down the dissolution and the ionization of the salts and oxidants. The kinetic rate of reaction is therefore relatively low, and the reaction is thus slow, which is evidently a cause of reduced performance.
b. To remain dissolved, the metal ions require a solution that is kept at a pH level of about 3. However, to comply with environment protection regulations of wastewater, the pH level must be adjusted to about 6. Hence, there is a need for a twofold adjustment of the pH level: one for the sake of the AOP, and second to comply with the regulations for wastewater disposal.

Attempts have been made to work with micro-balls coated with metal chelates, which provide faster reaction but at a cost so high that it proved unaffordable to industry.

In an effort to provide industry with catalysts featuring a large surface area for reaction's acceleration, nanoscale-chelates of catalyst have been developed.

By definition, chelants are organic molecules that form a coordinative bond with a metal a complex chemical unit, typically soluble in water. The chelates sometimes inactivate the chelated ions so that they cannot normally react with other elements or ions such as to produce precipitates or scale.

The use of nanoscale-chelates of catalyst in a chelate nanocrystal process, remediates the disadvantages described hereinabove of both conventionally utilized catalysts and of the coated micro-balls.

The result of the chelate formation is always better soluble in water. The metal ion-chelating agent complexes are soluble in a wider range of pH levels than the untreated, thus not chelated known catalysts. According to an embodiment, the metal ion-chelating agent complexes soluble in pH of 2 to 8, preferable in pH of 4 to 6. It is thereby possible to provide a superior process to easily operate a reaction at neutral pH levels, whereby the need for recurrent and expensive adjustment of pH levels is avoided. Such, the cost effectiveness of the CNP is manifold when compared to a conventional AOP or even to an enhanced AOP as described hereinabove.

At the first step to provide nanoscale-chelates of catalyst, the metal salts and/or oxides together with chemicals 40 are let to react with a chelating agent. Such chelating agent may be selected alone or in combination as acetic acid, hydroxy acetic acid, EDTA (ethylenediaminetetracetic acid), citric acid, phosphate requesting polymers, acrylic polymers, glycine, gluconate, tartrate, ethylene diamine and derivates, and mercaptans or thions and combination thereof.

At the second step, the metal ion-chelating agent complexes are exposed to high frequency ultrasonic cavitation. Thereby, the size of the metal ion-chelating agent complex chelates is reduced to a nano-size scale, which results in a significant increase of the metal surface area. Such an increase of metal surface area further increases the catalytic effect.

To produce nanoscale-chelates of catalyst, a chelated metal solution has to be prepared first. Such chelated metal solution contains:

One or more metal salts or oxidants, such as but not limited to Fe, Ti, Mn, Cu, Mo, or a mixture thereof, at weight/weight of metal salt or oxidant to chelates metal solution of 5% to 40%, preferably at 25%.

Chemicals 40, may be selected from the group consisting of oxidizers such as hydrogen peroxide, ozone, hypochloride, and the like.

One or more chelating agents, such as including peracetic acid, hydroxy acetic acid, EDTA, citric acid, phosphate sequesting polymers, acrylic polymers, mercaptans or a mixture thereof, at weight/weight of chelating agent to chelates metal solution of 5% to 50%, preferably at 25%.

Softened low-ionized water is added up to a balance of 100% of the concentrations of the metals and the chelating agents.

It is noted that the metal salts mixture may contain a plurality of different salts and metal oxidants, and that the relative concentration of the different salts and/or oxidants in the reaction solution may vary form 1 to 1 or more.

The preferred relation between the different metal salts is calculated according to the nature of treated solution 10. For example, within treated solution 10 which contains a high caffeine's concentration, the ratio between Fe and Mn to solution may be preferably selected from 3 to 10, respectively. If the wastewater contains a high concentration of phthalic acids, the ratio between Fe and Ti to solution may be preferably selected from 2 to 8, respectively.

To produce nanoscale-chelates of catalyst, a chelated metal solution may be placed in one or more beakers and/or chambers of 0.5 to 50 liters that are disposed in an ultrasonic water bath and/or are exposed to ultrasound cavitation in a flow-through reactor. The ultrasonic bath is then operated at a frequency ranging between 20 to 50 kHz, preferably at 35 kHz, at a power density of 0.1 to 2.5 kW h/m³ for an exposure time of 15 to 250 minutes, or preferably to 60 minutes. Thereafter, the obtained solution may be cooled to room temperature and stored away from UV light.

The nanoscale-chelates of catalyst produced according to the method described hereinabove present an augmented catalyst surface area resulting in an increased yield, a faster reaction rate, and a much-increased cost-effectiveness when compared to a conventional and even to an enhanced AOP.

In industrial wastewater, the complexity of organic contaminant elements may be very broad. Furthermore, industrial wastewater as treated solution 10 usually contains a large percentage of non-degradable complex organic matter, the decontamination of which requires a large variety of metal ion-chelating agent complexes. The method described hereinabove for the production of nanoscale-chelates of catalyst permits to formulate an enhanced product that may contain a mixed variety of catalyst metals. Such, it becomes possible to produce one solution of nanoscale-chelate crystals of catalyst that contains a plurality of different metal ions to be applied and used for the decontamination of a wide variety of industrial wastewaters. For example, one may formulate a blended mixture of catalysts that will be effective for specific treatment of more than one type of wastewater.

The CNP may further comprise the step of producing the selected nanoscale chelates of catalyst(s) by reacting at least one of the bivalent metal ions of Ti, Fe, Mg, Mo, and Cu with a chelating agent selected alone and in combination from a group including EDTA, Citric ACID, Hydroxy acetic acid, EDTA, Phosphate sequesting polymers, Acrylic polymers, and mercaptans or thions, to create a wide-range pH soluble complex of the metals and the chelating agent(s), and by treating the complex of the metals and the chelating agent(s) by disposition in an ultrasonic reactor having at least 50 W, for exposure to ultrasonic cavitation for a duration of 15 minutes to 250 minutes for at least one hour.

The CNP may form the selected nanoscale chelates of catalyst(s) to present an increased surface area larger by at least one order of magnitude relative to conventional catalysts.

The CNP may form the selected nanoscale chelates of catalyst(s) with an increased surface area enabling at least a twofold reaction kinetic constant increase.

The CNP may form the selected nanoscale chelate crystals catalyst(s) to enable optimal reaction in a treated solution having an acidity pH level of about 6.

The CNP may form the selected nanoscale chelate crystals catalyst(s) to present at least twofold level of solubility relative to conventional catalysts over a spectrum of pH levels ranging from 1 to 6.

The CNP may form the selected nanoscale chelate crystals catalyst(s) produced by chelation and nanoscaling processes, to permit treatment of wastewaters containing multi-components of organic contaminants, as a result of chelation and nanoscaling.

The CNP may operate with the same ultrasound equipment and with the same settings and parameters of operation as used by the enhanced AOP described hereinabove.

Thus, the CNP may comprise the step of selecting the width dimension WD ranging from 50 to 250 mm Optionally the width dimension WD can be 125 mm

The CNP may further comprise the step of selecting the frequency of operation of ultrasound transducers 26 from a group including a frequency ranging from 18 kHz to 30 kHz. Optionally the frequency of operation of ultrasound transducers 26 may be 25 kHz.

The CNP may also comprise the step of selecting the energetic load ranging from 0.2 to 0.7 kW h/m³. Optionally the energetic load may be 0.3 kW h/m³.

The CNP may comprise the step of forcing the treated solution to flow through at least one reactor chamber for a number of cycles. According to an embodiment, the number of cycles may be 2 to 8 cycles per hour, preferably 3 cycles per hour, also preferably 3 cycles per hour for up to two hours.

The CNP may comprise the step of adapting at least one reactor chamber for achieving an ultrasound cavitation exposure time of treated solution 10 for a period of between 2 to 15 seconds, preferably 8 to 15 seconds, more preferably for at least 12 seconds, also preferably for 12 seconds.

The CNP may comprise the step of applying first a pretreatment process prior to an intermediate process for removing oily matter selected alone and/or in combination from the group consisting of mineral oil, suspended solids, sedimentation of suspended solids originating from dissolved solids treated by precipitation or flotation, and the like.

The CNP may comprise the step of operating the enhanced AOP for a period ranging from 30 minutes to two hours and a half, and thereafter applying a post treatment process for removing metal ions from the treated solution.

The wastewater treatment procedures described hereinabove may be applicable in a variety of industries having solutions to be discarded, such as, but not limited to, chemical, electronic, agricultural, and other industries.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

### EXAMPLES

### Test and Results for the Enhanced AOP

A group of tests A, B, and C has been conducted to verify the improved performance achieved by the enhanced AOP.

A singular configuration and settings for ultrasound cavitation from the group of tests were selected as follows.

The ultrasound device was selected as a commercially available ultrasound device (provided by A. Shitzer Ltd., P.O. Box 33133, Haifa 31331, Israel) having a 1 kW h ultrasound reactor, (adapted to be operate at 35 kHz at an energy load between 0.3 to 1.0 kW h/m³) operating at 15 to 30 and preferably 20 kHz at an energy load of 0.3 kW h/m³ provided with a tubular ultra-sonic flow-through reactor. This tubular ultra-sonic flow-through reactor having a length L of one meter, and a diameter, or width WD, of 125 mm such, the reactor chamber was configured to have a volume Vᵣ of about 12.5 liters.

The treated test solution had a volume of Vₒ=50 liters, and contained a dose of 2000 ppm of Methyl Tertiary Butyl Ether (MTBE), dissolved in tap water (the W/W ratio between MTBE to H2O: 2000 ppm). Methyl Tertiary Butyl Ether is a contaminant results from fuel additives, and is known to cause underground contamination.

The metal catalyst was a combination based on Fe⁺² and Ti⁺², reported by literature to be the most effective (see publication “Study on Ultrasonic Degradation of Pentachlorophenol Solution”, N. Xu, X. P. Lu, and Y. R. Wang, Chem. Biochem. Eng. Q.20 (3) 343-347 (2006). The selected catalysts were TiO₂+FeSO₄ at a 200 ppm dosing rate, since literature recommends the dosage of the metal ions catalysts be 1/10 of the COD level of contamination (see publication “Determination of the Ultrasonic Effectiveness in Advanced Wastewater Treatment”, S. Nasseri, F. Vaezi, A. H. Mahvi, R. Nabizadeh, S. Haddadi, Iran. J. Environ. Health. Sci. Eng., 2006, Vol. 3, No. 2, pp. 109-116).

The pH level of the treated test solution was adjusted to a level of about 2.8 to 3.

According to literature, the oxidant was selected as hydrogen peroxide at 30%, at a dose of 2000 ppm, to equal the level of 2000 ppm of the COD reading.

Reaction duration of 30 minutes was selected.

### Tests A: Number of Cycles and Exposure Time Effect on COD Reduction

Tests A include a series of four separate tests made to determine the optimal number of cycles, and exposure time of the treated test solution to achieve the best COD reduction efficiency.

The settings of tests A included:
Number of cycles per hour, through the ultrasound reactor chamber: 3, 5, 7 and 10,
Exposure time in seconds to ultrasound cavitation per cycle: 12, 10.6, 7.4, and 5.2.
Reaction duration time: 30 min/treat.

The COD reduction reading results of the treated test solutions are listed in Table 1 and shown in FIG. 3.

TABLE 1

| | | | |
|---|---|---|---|
| Tests | | Exposure time/ | % of COD |
| A # | Cycles/h. | cycle [seconds] | reduction |

| | | |
|---|---|---|
| 0 | Raw water | 0 |

| | | | |
|---|---|---|---|
| 1 | 3 | 12 | 42.74 |
| 2 | 5 | 10.6 | 32.52 |
| 3 | 7 | 7.4 | 14.93 |
| 4 | 10 | 5.2 | 10.00 |

The most effective COD reduction, almost 43%, was obtained at three cycles of flow per hour, and exposure time to ultrasound cavitation of 12 seconds.

### Tests B: Energetic Load or Power Density Effect on COD Reduction

Tests B include a series of four separate tests made to determine the optimal energetic load intensity effect on the treated test solution, to achieve the best COD reduction efficiency.

The settings of tests B included:
Number of cycles/h, number of cycles of flow per hour through the ultrasound reactor chamber: 3.
Exposure time to ultrasound cavitation per cycle: 12 sec.
Reaction duration time: 30 min/treat.

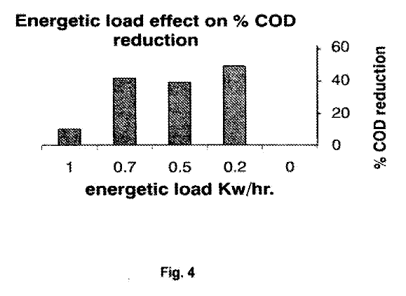

The COD reading results of the treated test solutions are listed in Table 2 and shown in FIG. 4.

TABLE 2

| Tests | Energetic load | COD reading | % of COD |
|---|---|---|---|
| B # | [kW h/m³] | [ppm] | reduction |
| control | 0 | 2106 | 0 |
| 1 | 0.3 | 1080 | 46 |
| 2 | 0.5 | 1230 | 38.5 |
| 3 | 0.7 | 1180 | 41 |
| 4 | 1.0 | 1800 | 10 |

The most effective COD reduction 46%, was obtained at an energetic load density of between 0.2 and 0.3 kW h/m³.

### Tests C: Reaction Duration Time Effect on COD Reduction

Tests C include a series of five separate tests made to determine the optimal reaction duration time, and the effect of the reaction duration time on the treated test solution, to achieve the best COD reduction efficiency.

The settings of tests C included:
Number of cycles/h, number of cycles of flow per hour through the ultrasound reactor chamber: 3
Exposure time to ultrasound cavitation per cycle: 12 sec
Reaction duration time in min per treat: 30, 60, 90, 120, and 150

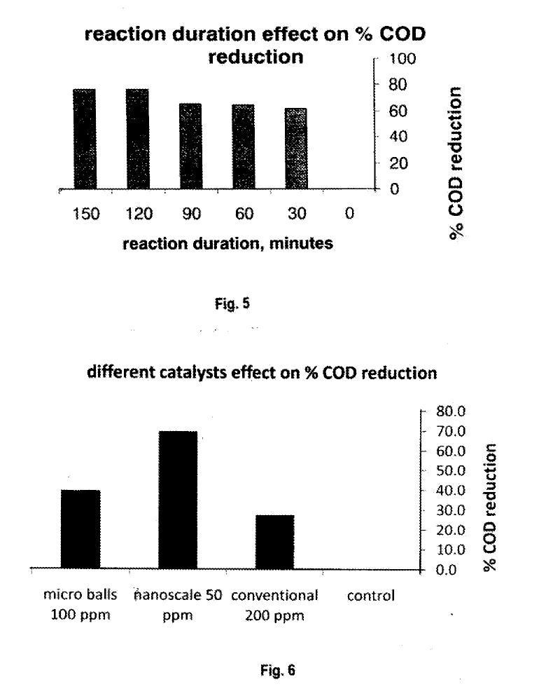

The COD reading results of the treated test solutions are listed in Table 3 and shown in FIG. 5.

TABLE 3

| Tests | Reaction | COD reading | % of COD |
|---|---|---|---|
| C # | duration [min] | [ppm] | reduction |
| control | 0 | 2106 | 0 |
| 1 | 30 | 800 | 62 |
| 2 | 60 | 744 | 64.6 |
| 3 | 90 | 730 | 65.3 |
| 4 | 120 | 600 | 71.5 |
| 5 | 150 | 596 | 76 |

It was found that there is a direct relation between the reaction duration time and the percentage of reduction the COD level.

The most effective COD reduction in Tests C, was 76%, is obtained at a reaction time of 150 min.

In conclusion, the enhanced AOP may be adapted for use for decontamination of industrial wastewater that is untreatable by common biologic degradation methods.

Test and Results with the Chelate Nanocrystal Process CNP

A group of tests D, E, and F has been conducted to verify the improved performance achieved by the use of the crystal in the chelate nanocrystal process. The following is common to the various tests described hereinbelow.

The singular configuration and the settings of the ultrasound cavitation were selected as follows—

Ultrasound device was a commercially available ultrasound device having 1 kW h ultrasound reactor, operating at 35 kHz at an energy load of 0.3 kW h/m³, provided with a tubular ultra-sonic flow-through reactor having a diameter, or width WD, of 125 mm.

The treated test solution contained a dose of 2000 ppm of Methyl Tertiary Butyl Ether (MTBE) (made by Dor Chemicals, Israel), dissolved in tap water. Methyl Tertiary Butyl Ether is a contaminant originating from fuel additives, and is known to cause underground contamination.

Reaction duration was 30 minutes. Exposure time to ultrasound cavitation was 12 seconds per cycle.

Tests A to F were conducted at a temperature of about 20 degrees Celsius, but the same results would have been obtained for temperatures between 15 to 40 degrees Celsius.

### Tests D: Catalyst Effect on COD Reduction

To determine catalyst ability to achieve the best COD reduction efficiency tests D include a series of three separate tests made to determine the effect of the addition of different kinds of catalysts to the treated test solution,. The settings of tests D include the following:

The three selected catalysts were:
Conventional catalyst, such as TiO2+FeSO4 at a concentration of 200 ppm,
Ti-coated glass micro-balls, with a dosing rate of 100 ppm,
Nanoscale-chelate crystals, at a concentration of 50 ppm.
The pH level of the treated solution was adjusted to 4.5.

The COD reading results obtained after post-treatment of the treated test solution are listed in Table 4 and shown in FIG. 6.

TABLE 4

| Tests | | Dose | COD reading | % of COD |
|---|---|---|---|---|
| D # | Catalyst | [ppm] | [ppm] | reduction |
| 0 | control | 0 | 2106 | 0 |
| 1 | conventional | 200 | 1525 | 27.6 |
| 2 | glass micro balls | 100 | 1275 | 39.5 |
| 3 | nanoscale chelate crystals | 50 | 640 | 69.6 |

The most effective COD reduction in Tests D, almost 70%, was obtained with the nanoscale chelate crystals at a concentration of 50 ppm.

### Tests E: Effect of Nanoscale Chelate Crystals Dosages on COD Reduction

The tests E include a series of five separate tests made to determine the effect of the addition of different dosages of nanoscale chelate crystals to the treated test solution, to determine the concentration necessary to achieve the best COD reduction efficiency. The settings of tests E include the following:

The selected catalysts were:
Nanoscale chelate crystals, dosed at 200, 150, 100 and 50 ppm,
Conventional catalyst, such as TiO₂+FeSO₄ at a concentration of 200 ppm.

The pH level of the treated solution was adjusted to 4.5.

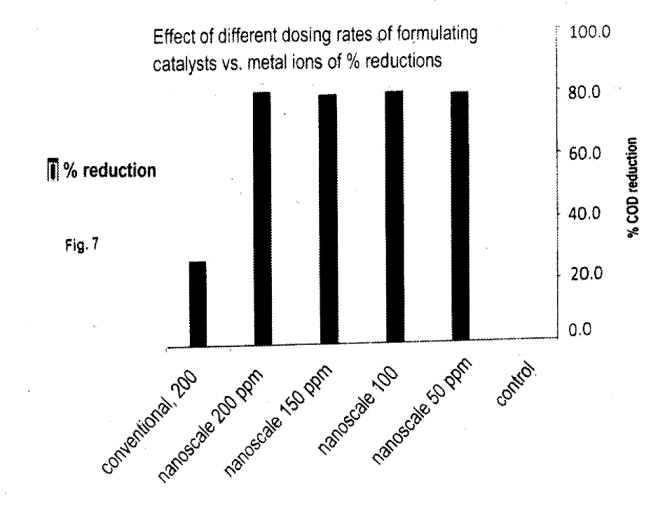

The COD reading results obtained after post-treatment of the treated test solution are listed in Table 5 and shown in FIG. 7.

TABLE 5

| Tests | | Dose | COD reading | % of COD |
|---|---|---|---|---|
| E # | Catalyst | [ppm] | [ppm] | reduction |
| 0 | control | 0 | 2106 | 0 |
| 1 | Nanoscale chelate crystals | 50 | 420 | 80.1 |
| 2 | Nanoscale chelate crystals | 100 | 405 | 80.8 |
| 3 | Nanoscale chelate crystals | 150 | 415 | 81.3 |
| 4 | Nanoscale chelate crystals | 200 | 389 | 81.5 |
| 5 | Conventional Ti + Fe | 200 | 1525 | 27.6 |

With the use of nanoscale-chelate crystals, the differences between the COD reduction in Tests E, for variant dosages of nanoscale catalyst is minimal. Hence, the most cost effective choice is to opt for a concentration of 50 ppm of nanoscale chelate crystals catalyst, to achieve a COD reduction of above 80%.

Tests F: Effect of the pH Level on the COD Reduction with Nanoscale Chelate Crystals Dosed at 50 ppm

In order to determine the pH of the treated solution necessary for achieving the best COD reduction efficiency, tests F include a series of three separate tests made to determine the effect of the pH level on the COD reduction with the addition of nanoscale chelate crystals dosed at 50 ppm to the treated test solution, to. The settings of tests F included the following.

The selected catalysts were nanoscale chelate crystals-Ti and Fe nanoscale-chelate crystals dosed at 50 ppm.

The pH level of the treated solution was adjusted to 3, 4.5, and 6.

The COD reading results obtained after post-treatment of the treated test solution 10 are listed in Table 6 and shown in FIG. 8.

TABLE 6

| Tests | Catalyst | pH | COD reading | % of COD |
|---|---|---|---|---|
| F # | at 50 ppm | level | [ppm] | reduction |
| 0 | control | 0 | 2100 | 0 |
| 1 | nanoscale chelate crystals | 3 | 600 | 71.4 |
| 2 | nanoscale chelate crystals | 4.5 | 600 | 71.5 |
| 3 | nanoscale chelate crystals | 6 | 670 | 68.5 |

With the use of nanoscale chelate crystals, the difference between the COD reduction in tests F for dosages of 50 ppm over a range of pH levels from 3 to 6 is minimal. Hence, the most cost effective choice is to adjust the treated solution to pH 6, to achieve a COD reduction of almost 70%.

It is noted that Tests A-F were conducted at a temperature range of about 20 degrees Celsius, but the same results would have been obtained for a range of 15 to 40 degrees Celsius.

1. An advanced oxidation procedure for treating solution 10 of waste water, comprising:
applying an ultrasound-Fenton reaction, wherein said ultrasound-Fenton reaction includes:
providing oxidants 40 and at least catalyst 50, wherein said at least one catalyst is selected from the group consisting of a group of bivalent metal ions which includes Ti, Fe, Mg, Mo, and Cu;
subjecting the treated solution 10 and said oxidants 40 and at least catalyst 50 to ultrasound cavitation generated by generator device 20;
forcing a flow of treated solution 10 through said ultrasound device 20 adapted to generate ultrasound waves for forming cavitation in said treated solution 10, said flow of treated solution 10 passing through at least one flow-through tubular reactor chamber 24 of the ultrasound device 20, and wherein said cavitation is effected by longitudinally linear distributed string of ultrasound transducers 26 fixedly disposed and attached along a length L of said at least one tubular reactor chamber 24, and wherein said cavitation is effected along a width dimension WD of said reactor chamber 24, and wherein said ultrasound transducers 26 emit a frequency in a range of 15 kHz to 50 kHz, at an energetic load of 0.1 to 1.5 kW h/m³.

2. The AOP according to claim 1, wherein said subjecting further comprises at least one step selected alone and/or in combination from a group consisting of measuring a COD level, measuring a TOC level, and adjusting a pH level.

3. The AOP according to claim 1, wherein said at least one flow-through tubular reactor chamber 24 comprises:
said length dimension L, and a first reactor wall having a reactor inlet IN through which said treated solutions 10 enters the at least one reactor chamber and flows to a second reactor wall having a reactor outlet OUT through which the treated solution 10 exits out of the at least one reactor chamber, and
said diameter WD, or a width dimension WD perpendicular to the reactor chamber length L, which width dimension is ranging from 25 to 300 mm.

4. The AOP according to claim 1, future comprises the step of: forcing the treated solution 10 to flow through the at least one reactor chamber 24 for a number of cycles selected from a group consisting of 1 to 10 cycles per hour, wherein said forcing is adapted to be controlled by a circulation pump 30, and wherein the at least one reactor chamber 24 is adapted for achieving an ultrasound cavitation exposure time of the treated solution for a period of time of 1 to 60 seconds.

5. The AOP according to claim 1, wherein the width dimension WD is between 50 to 250 mm.

6. The AOP according to claim 1, wherein the width dimension WD is 125 mm.

7. The AOP according to claim 1, wherein the frequency of operation of the ultrasound transducers 26 is adapted to emit 15 kHz to 50 kHz.

8. The AOP according to claim 1, wherein the frequency of operation of the ultrasound transducers is adapted to emit 25 kHz.

9. The AOP according to claim 1, wherein the energetic load is between 0.2 to 0.7 kW h/m³.

10. The AOP according to claim 1, wherein the energetic load is adapted to 0.3 kW h/m³.

11. The AOP according to claim 1, further comprising the step of:
forcing the treated solution to flow through the at least one reactor chamber 24 for a number of cycles, wherein said number of cycles is adapted to 2 to 8 cycles per hour.

12. The AOP according to claim 1, further comprising the step of:
forcing the treated solution to flow through the at least one reactor chamber 24 for 3 cycles per hour.

13. The AOP according to claim 1, further comprising the step of:
forcing the treated solution to flow through the at least one reactor chamber 24 for 3 cycles per hour for up to two hours.

14. The AOP according to claim 1, further comprising the step of:
adapting the at least one reactor chamber for achieving an ultrasound cavitation exposure time of the treated solution for a period of time of 2 to 15 seconds.

15. The AOP according to claim 1, further comprising the step of:
adapting the at least one reactor chamber for achieving an ultrasound cavitation exposure time of the treated solution for a period of time of 8 to 15 seconds.

16. The AOP according to claim 1, further comprising the step of:
adapting the at least one reactor chamber 24 for achieving an ultrasound cavitation exposure time of the treated solution for a period of time of at least 12 seconds.

17. The AOP according to claim 1, further comprising the step of:
applying a pretreatment process prior to the ultrasound-Fenton reaction for removing oily matter selected alone and/or in combination from the group consisting of mineral oil, suspended solids, and sedimentation of suspended solids originating from dissolved solids treated by precipitation or flotation.

18. The AOP according to claim 1, further comprising the steps of:
operating the AOP for a period of two hours, and thereafter
applying a post treatment process for removing metal ions from the treated solution 10.

19. An advanced oxidation procedure using nanoscale-chelate crystals catalyst in a chelate nanocrystal process comprising:
applying an ultrasound-Fenton reaction, wherein said ultrasound Fenton reaction including:
providing oxidants 40 and at least catalyst 50, wherein said at least one catalyst is selected from the group consisting of bivalent metal ions which includes Ti, Fe, Mg, Mo, and Cu;
subjecting the treated solution 10 and said oxidants 40 and at least catalyst 50 to ultrasound cavitation generated by generator device 20, wherein said ultrasound cavitation produces said nanoscale-chelate of catalyst in a formulation kept active in a multi-metal solution, wherein said nanoscale-chelates of catalyst is adapted to at least twofold level of solubility relative to a conventional catalyst in spectrum of pH levels ranging from 1 to 6, and
forcing a flow of treated solution 10 and said nanoscale-chelates of catalyst through said ultrasound device 20 adapted to generate ultrasound waves for forming cavitation in said treated solution 10, said flow of treated solution 10 passing through at least one flow-through tubular reactor chamber 24 of the ultrasound generator device 20, and wherein said cavitation is effected by longitudinally distributed linear string of ultrasound transducers 26 fixedly disposed and attached along a length L of said at least one tubular reactor chamber 24, and wherein said cavitation is effected along a width dimension WD of said reactor chamber 24, and wherein said ultrasound transducers 26 emit a frequency in a range of 15 kHz to 50 kHz, at an energetic load of 0.1 to 1.5 kW h/m³.

20. The CNP according to claim 19, wherein said subjecting further comprises at least one step selected alone and/or in combination from a group consisting of measuring a COD level, measuring a TOC level, and adjusting a pH level.

21. The CNP according to claim 19, wherein said at least one flow-through tubular reactor chamber 24 comprises:
said length dimension L, and a first reactor wall having a reactor inlet IN through which said treated solutions 10 enters the at least one reactor chamber and flows to a second reactor wall having a reactor outlet OUT through which the treated solution 10 exits out of the at least one reactor chamber, and
said diameter WD, or a width dimension WD perpendicular to the reactor chamber length L, which width dimension is ranging from 25 to 300 mm.

22. The CNP according to claim 19, future comprises the step of: forcing the treated solution 10 to flow through the at least one reactor chamber 24 for a number of cycles selected from a group consisting of 1 to 10 cycles per hour, wherein said forcing is adapted to be controlled by a circulation pump 30, and wherein the at least one reactor chamber 24 is adapted for achieving an ultrasound cavitation exposure time of the treated solution for a period of time of 1 to 60 seconds.

23. The CNP according to claim 19, wherein said selected nanoscale chelates of catalyst is adapted to be produced by
reacting at least one of the bivalent metal ions of Ti, Fe, Mg, Mo, and Cu with a chelating agent selected alone and/or in combination from the group consisting of EDTA, citric acid, hydroxy acetic acid, phosphate sequesting polymers, acrylic polymers, and mercaptans or thions, to create a wide-range pH soluble complex, and
treating the wide-range pH soluble complex by disposition in said ultrasound reactor 24 having at least 50 W to 1000 W, and exposure to ultrasonic cavitation for a duration of 15 minutes to 150 minutes for at least 60 minutes.

24. The CNP according to claim 23, wherein:
the selected nanoscale chelates of catalyst present an increased surface area larger by at least one order of magnitude relative to a conventional catalyst.

25. The CNP according to claim 19, wherein the increased surface area of the selected nanoscale chelates of catalyst enables at least a twofold reaction kinetic constant increase.

26. The CNP according to claim 19, wherein
the selected nanoscale chelates of catalyst enables optimal reaction in a treated solution having an acidity pH level of about 6.

27. The CNP according to claim 19, wherein
the selected nanoscale chelates of catalyst produced by chelation and nanoscaling processes, is adapted to treat wastewaters containing multi-components of organic contaminants as a result of chelation and nanoscaling.

28. The CNP according to claim 19, wherein said width dimension WD is between 50 to 250 mm.

29. The CNP according to claim 19, wherein said width dimension WD is 125 mm.

30. The CNP according to claim 19, wherein said ultrasound transducers 26 is adapted to emit a frequency of 15 kHz to 50 kHz.

31. The CNP according to claim 19, wherein said ultrasound transducers is adapted to emit a frequency of 25 kHz.

32. The CNP according to claim 19, wherein the energetic load is between 0.2 to 0.7 kW h/m³.

33. The CNP according to claim 19, wherein the energetic load is adapted to 0.3 kW h/m³.

34. The CNP according to claim 19, further comprising the step of:
forcing the treated solution to flow through the at least one reactor chamber 24 for a number of cycles, wherein said number of cycles is adapted to 2 to 8 cycles per hour.

35. The CNP according to claim 19, further comprising the step of:
forcing the treated solution to flow through the at least one reactor chamber 24 for 3 cycles per hour.

36. The CNP according to claim 19, further comprising the step of:
forcing the treated solution to flow through the at least one reactor chamber 24 for 3 cycles per hour for up to two and a half hours.

37. The CNP according to claim 19, further comprising the step of:
adapting the at least one reactor chamber 24 for achieving an ultrasound cavitation exposure time of the treated solution for a period of time of 2 to 15 seconds.

38. The CNP according to claim 19, further comprising the step of:
adapting the at least one reactor chamber 24 for achieving an ultrasound cavitation exposure time of the treated solution for a period of time of 8 to 15 seconds.

39. The CNP according to claim 19, further comprising the step of:
adapting the at least one reactor chamber 24 for achieving an ultrasound cavitation exposure time of the treated solution for a period of time of at least 12 seconds.

40. The CNP according to claim 19, further comprising the step of:
applying a pretreatment process for removing oily matter selected alone and/or in combination from a group consisting of mineral oil, suspended solids, and sedimentation of suspended solids originating from dissolved solids treated by precipitation or flotation.

41. The CNP according to claim 19, further comprising the steps of:
operating the enhanced advanced oxidation procedure for a period of two and one half hours, and thereafter
applying a post treatment process for removing metal ions from the treated solution.
